(19) United States
(12) Patent Application Publication
(10) Pub. No.: US 2024/0070515 A1
(43) Pub. Date: Feb. 29, 2024

(54) ENTROPY OF PREDICTIVE DISTRIBUTION (EPD)-BASED CONFIDENCE SYSTEM FOR AUTOMOTIVE APPLICATIONS OR OTHER APPLICATIONS

(71) Applicant: Canoo Technologies Inc., Torrance, CA (US)

(72) Inventors: Jongmoo Choi, Gardena, CA (US); Phillip Vu, Calabasas, CA (US); Lei Cao, Torrance, CA (US); Sai Anitha Kiron Vedantam, Los Angeles, CA (US)

(21) Appl. No.: 17/821,962

(22) Filed: Aug. 24, 2022

(51) Int. Cl. G06N 20/00

(52) U.S. Cl. CPC G06N 20/00; B60W 60/0015

(57) ABSTRACT

A method includes performing data processing operations using multiple functional modules. Each functional module is configured to perform one or more data processing operations in order to process input data and generate output data. The method also includes, for each functional module, generating a confidence measure associated with the output data generated by the functional module. At least two of the functional modules are configured to operate logically sequentially such that (i) a first of the functional modules provides the output data generated by the first functional module to a second of the functional modules and (ii) the confidence measure associated with the output data generated by the second functional module is based at least partially on the confidence measure associated with the output data generated by the first functional module. The multiple functional modules include heterogeneous functional modules configured to generate different types of output data.

### TECHNICAL FIELD

This disclosure relates generally to prediction systems. More specifically, this disclosure relates to an entropy of predictive distribution (IED)-based confidence system for automotive applications or other applications.

### BACKGROUND

Various automotive applications have been developed that use machine learning models or other logic to process input data from sensors or other sources and generate outputs for further use. For example, in an advanced driving assist system (ADAS) or autonomous driving (AD) application, information from one or more physical sensors (such as one or more cameras) can be processed in order to model a real-world environment around a vehicle. The modeled real-world environment around the vehicle may then be used for control purposes or other purposes, such as to adjust the speed or direction of travel of the vehicle or to alert an operator of the vehicle. As another example, in a driver monitoring system (DMS) application, information from one or more physical sensors (such as one or more cameras) can be processed in order to identify one or more characteristics of an operator of a vehicle. The one or more characteristics of the operator may then be used for various purposes, such as to alert the operator or another party when it appears that the operator is inattentive, distracted, drowsy, or otherwise acting unsafely while driving the vehicle.

### SUMMARY

This disclosure relates to an entropy of predictive distribution (EPD)-based confidence system for automotive applications or other applications.

In a first embodiment, a method includes performing data processing operations using multiple functional modules. Each functional module is configured to perform one or more data processing operations in order to process input data and generate output data. The method also includes, for each functional module, generating a confidence measure associated with the output data generated by the functional module. At least two of the functional modules are configured to operate logically sequentially such that (i) a first of the functional modules provides the output data generated by the first functional module to a second of the functional modules and (ii) the confidence measure associated with the output data generated by the second functional module is based at least partially on the confidence measure associated with the output data generated by the first functional module. The multiple functional modules include heterogeneous functional modules configured to generate different types of output data.

In a second embodiment, an apparatus includes at least one processing device configured to perform data processing operations using multiple functional modules. Each functional module is configured to perform one or more data processing operations in order to process input data and generate output data. The at least one processing device is also configured, for each functional module, to generate a confidence measure associated with the output data generated by the functional module. At least two of the functional modules are configured to operate logically sequentially such that (i) a first of the functional modules is configured to provide the output data generated by the first functional module to a second of the functional modules and (ii) the confidence measure associated with the output data generated by the second functional module is based at least partially on the confidence measure associated with the output data generated by the first functional module. The multiple functional modules include heterogeneous functional modules configured to generate different types of output data.

In a third embodiment, a non-transitory machine-readable medium contains instructions that when executed cause at least one processing device to perform data processing operations using multiple functional modules. Each functional module is configured to perform one or more data processing operations in order to process input data and generate output data. The medium also contains instructions that when executed cause the at least one processing device, for each functional module, to generate a confidence measure associated with the output data generated by the functional module. At least two of the functional modules are configured to operate logically sequentially such that (i) a first of the functional modules is configured to provide the output data generated by the first functional module to a second of the functional modules and (ii) the confidence measure associated with the output data generated by the second functional module is based at least partially on the confidence measure associated with the output data generated by the first functional module. The multiple functional modules include heterogeneous functional modules configured to generate different types of output data.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example system supporting an entropy of predictive distribution (EPD)-based confidence system according to this disclosure;

FIGS. 2A through 2C illustrate example operations of functional modules and EPD modules in an EPD-based confidence system according to this disclosure;

FIG. 3 illustrates an example method for using an EPD-based confidence system according to this disclosure;

FIG. 4 illustrates an example design flow for employing, one or more tools to design hardware that implements one or mote functions according to this disclosure; and

FIG. 5 illustrates an example device supporting execution of one or more tools to design hardware dial implements one or more functions according to this disclosure.

### DETAILED DESCRIPTION

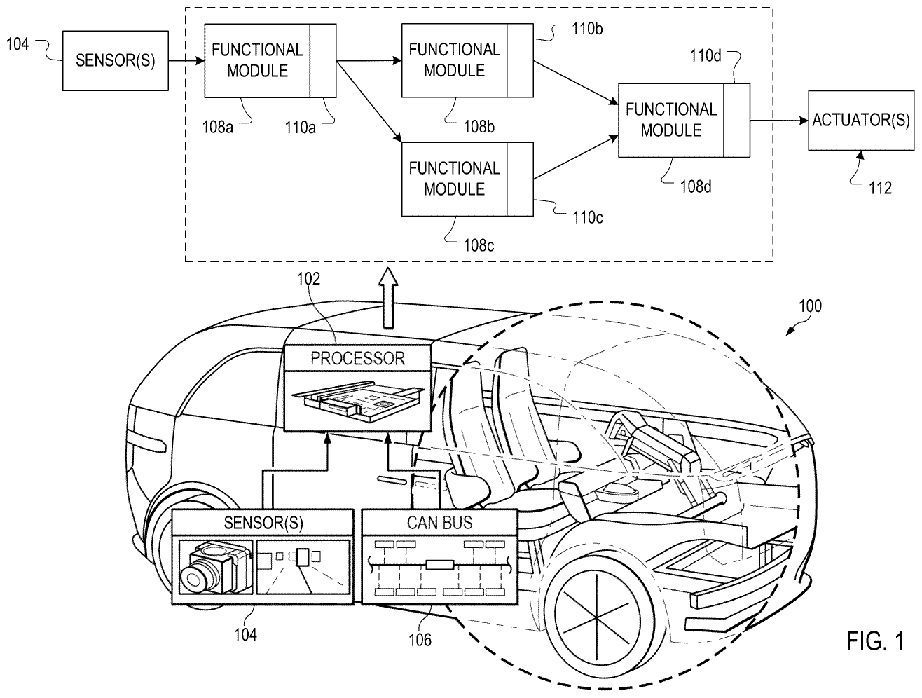

FIGS. 1 through 5, described below, and the various embodiments used to describe the principles of this disclosure are by way of illustration only and should not be construed in any way to limit the scope of this disclosure. Those skilled in the art will understand that the principles of this disclosure may be implemented in any type of suitably arranged device or system.

As noted above, various automotive applications have been developed that use machine learning models or other logic to process input data from sensors or other sources and generate outputs for further use. For example, in an advanced driving assist system (ADAS) or autonomous driving (AD) application, information from one or more physical sensors (such as one or more cameras) can be processed in order to model a real-world environment around a vehicle. The modeled real-world environment around the vehicle may then be used for control purposes or other purposes, such as to adjust the speed or direction of travel of the vehicle or to alert an operator of the vehicle. As another example, in a driver monitoring system (DMS) application, information from one or more physical sensors (such as one or more cameras) can be processed in order to identify one or more characteristics of an operator of a vehicle. The one or more characteristics of the operator may then be used for various purposes, such as to alert the operator or another party when it appears that the operator is inattentive, distracted, drowsy, or otherwise acting—unsafety while driving the vehicle.

Unfortunately, these types of processes often involve the processing of noisy measurements or other noisy input data and the use of simplified computational models. As a result, modeled real-world environments, vehicle operator characteristics, or other outputs that are generated often represent incomplete or uncertain estimates. Moreover, when these outputs are further processed in order to make final determinations of actions to be taken in response to those outputs, the final decisions may not be particularly reliable. This can be particularly problematic in situations such as those where sensor measurements or other input data is severely contaminated or where a sensor or other source of input data has failed. Existing ADAS/AD and DMS systems typically generate deterministic outputs, Which means that the outputs are produced and provided without any consideration of the quality or validity of those outputs.

As a particular example of this, a DMS system may be used to implement a driver attentiveness warning system, which can process input data to produce classified labels like “safe,” “moderately safe,” “unsafe,” or “extremely unsafe” describing how a vehicle operator is behaving depending on one or more identified characteristics of the vehicle operator. Warnings or other actions may be initiated in response to one or more of the classified labels being generated, such as when an audible alert is provided to the vehicle operator or a notification is sent to another party in response to an “unsafe” or “extremely unsafe” classification. However, in these types of systems, there is no way to convey the validity of the generated estimates (the classified labels) if the system only provides the discrete labels. Thus, if the system provides “safe” as an output, it is impossible to differentiate between a “safe” estimate with a 99% confidence and a “safe” estimate with a 30% confidence, even if some subsystems support the concept of confidence internally. As a result, the system cannot provide probabilistic estimates or results with associated confidences unless the entire system is designed and engineered to handle such uncertainties throughout its entire pipeline. If a warning system or other system is directly connected to the control system of a vehicle, deciding to initiate a corrective action without consideration of the associated uncertainty can be dangerous and might even produce fatal accidents. Even if a warning system or other system is not connected to a vehicle's control system, providing incorrect outputs (such as providing an arbitrary attentiveness warning when a camera provides a damaged or corrupted input) reduces the overall value of the warning system or other system.

While various approaches have been used to identify the confidence or confidence level of an individual output, these approaches can suffer from a number of shortcomings. For example, some of these approaches may be designed for use with specific types of tasks, which makes use of these approaches difficult in other applications. Also, some of these approaches may be useful only while processing one-dimensional or low-dimensional input data, which makes use of these approaches difficult in applications where large amounts of high-dimensional input data may be available. In addition, some systems may perform various operations that produce outputs having different dimensionalities, and these approaches are generally unable to combine different predictive distributions in order to make a fused uncertainty determination for final output values.

This disclosure provides various approaches for implementing an entropy of predictive distribution (EPD)-based confidence system. As described in more detail below, an ADAS/AD system, DMS system, or other system includes multiple functional modules, each of which is generally configured to receive input data and generate output data. The functions performed by the functional modules can vary based on the specific system being implemented. Each functional module is associated with an EPD module, which may be integrated into or otherwise used in conjunction with the associated functional module. Each EPD module is configured to process information (such as the input data received by the associated functional module, the output data generated by the associated functional module, or intermediate data generated by the associated functional module) in order to identify a confidence associated with the output data generated by the associated functional module. Each determined confidence may be expressed in any suitable manner, such as a percentage. Depending on the arrangement of the functional modules, one or more subsequent EPD modules for one or more of the functional modules may receive and process confidences determined by one or more earlier EPD modules. In some cases, a final EPD module associated with a final functional module can generate and output a confidence associated with a final output of the system formed by the functional modules.

In this way, the EPD modules collectively form an EPD-based confidence system that uses entropy of predictive distribution as the building block to represent a measure of confidence within the system. The EPD modules can be used to collectively provide an aggregated system-level confidence associated with an output from the system, even when individual functional modules in the system are not designed specifically to produce measures of confidence related to their outputs. Also, these approaches can be used in systems that include multiple heterogeneous functional modules, meaning the functional modules can produce different types of outputs (possibly including outputs having different dimensionalities). As a result, EPD-based confidence measures can be used to provide unified representations of confidence for different types of functional modules. Further, these approaches can be used even when high-dimensional input data is available and being processed. In addition, an EPD confidence measure can be expressed as a single value, and it can be simple and efficient to update a confidence with multiple inputs and other related confidences. Finally, since an EPD confidence measure is independent of unit or scale, the EPD confidence measure may not require an additional step to normalize the confidence measure or otherwise post-process the confidence measure (although some embodiments may post-process the confidence measure in any desired manner).

Note that in the following discussion, the terms “certainty” and “confidence” may be used interchangeably, where both terms refer to a measure of the estimated validity of output data produced using a functional module. Also note that, in some embodiments, it is possible to differentiate between the accuracy and the precision of output data generated by the functional module when determining certainty or confidence. Accuracy generally relates to how close the output data is to reality, meaning accuracy represents how close generated results are to their associated ground truths. Precision generally relates to how close multiple instances of the output data are to themselves, meaning precision represents how reproducible or repeatable the output data is. A system may be considered “valid” if the system is both accurate and precise. In general, the confidence associated with output data may be high if the system believes that the output data is close to the ground truth(s) and the precision of the system is high. In this document, in some embodiments, for simplicity it may be assumed that (i) the bias of a system is zero or the system can be calibrated and (ii) the precision of the system depends on the quality of its input data (which means that the system is accurate and that the precision of the system is not constant). In those embodiments, certainty or confidence measurements may represent a measure of the estimated validity of output data produced using the functional modules of the system, where the estimated validity considers only the precision and not the accuracy of the system. However, other embodiments of the described approaches may be used in which both the accuracy and the precision of the system are considered.

FIG. 1 illustrates an example system 100 supporting an EPD-based confidence system according to this disclosure. In this particular example, the system 100 takes the form of an automotive vehicle, such as an electric vehicle. However, any other suitable system may support the use of EPD-based confidence, such as other types of vehicles, autonomous robots, or other autonomous or non-autonomous systems.

As shown in FIG. 1, the system 100 includes at least one processor 102 configured to control one or more operations of the system 100. In this example, the processor 102 may interact with one or more sensors 104 and with one or more components coupled to a bus 106. In this particular example, the one or more sensors 104 include one or more cameras or other imaging sensors, and the bus 106 represents a controller area network (CAN) bus. However, the processor 102 may interact with any other or additional sensor(s) and communicate over any other or additional bus(es).

When the one or more sensors 104 include one or more cameras, the one or more cameras can generate images of scenes around and/or within the system 100. The images can be used by the processor 102 or other component(s) to perform one or more functions, such as object detection, operator detection, eyelid detection, or gaze detection. In some cases, the sensors 104 may include a single camera, such as one camera positioned on the front of a vehicle. In other cases, the sensors 104 may include multiple cameras, such as one camera positioned on the front of a vehicle, one camera positioned on the rear of the vehicle, and two cameras positioned on opposite sides of the vehicle. In still other cases, the sensors 104 may include at least one camera configured to capture images of scenes around the vehicle and/or at least one camera configured to capture images of scenes within the vehicle. Note that any other or additional types of sensors 104 may be used here, such as one or more radio detection and ranging (RADAR) sensors, light detection and ranging (LIDAR) sensors, other types of imaging sensors, or inertial measurement units (IMUs). In general, this disclosure is not limited to any particular number of cameras or other sensors or—to any particular positions of those cameras or other sensors.

Measurements, such as images or other data, from the one or more sensors 104 are used by the processor 102 or other component(s) to perform one or more desired functions. For example, the processor 102 can process images or other data from the one or more sensors 104 in order to detect objects around, proximate to, or within the system 100, such as one or more vehicles, obstacles, or people near the system 100 or an operator of the system 100. The processor 102 can also process images or other data from the one or more sensors 104 in order to perceive lane-marking lines or other markings on a road, floor, or other surface. The processor 102 can further process images or other data from the one or more sensors 104 to generate predictions associated with the system 100, such as to predict the future path(s) of the system 100 or other vehicles, identify a center of a lane in which the system 100 is traveling, or predict the future locations of objects around the system 100. In addition, the processor 102 can process images or other data from the one or more sensors 104 in order to identify one or more characteristics of the operator of the system 100, such as eyelid positions of the operator or a gaze direction of the operator. Note, however, that the images or other measurement data from the sensors 104 can be used by the processor 102 or other component(s) in any other suitable manner.

In this example, the processor 102 is used to execute or otherwise implement multiple functional modules, which in this particular example include four functional modules 108a-108d. Each functional module 108a-108d is configured to receive input data (possibly multiple types of input data) from one or more sources, process the input data, and generate output data (possibly multiple types of output data). As shown in the example of FIG. 1, the functional module 108a operates based on images or other measurement data from the sensors 104, and the functional modules 108b-108d operate based on output data from at least one preceding functional module. A final functional module 108d produces one or more final outputs. Note, however, that each of the functional modules 108a-108d may receive and process data from any other or additional source(s).

In general, each of the functional modules 108a-108d may perform any desired function or functions so that the collection of the functional modules 108a-108d processes the images or other measurement data from the sensors 104 and produces desired outputs. Many intelligent systems that process real-world data involve the use of multiple functional modules 108a-108d, each of which may often be designed to perform one or more specific functions. For example, in ADAS/AD applications, multiple functional modules 108a-108d can be used to process input data from one or multiple types of sensors 104, estimate a real-world environment around the system 100 based on the sensor measurements, and make predictions about or associated with the system 100. Example predictions about or associated with the system 100 could include a prediction whether the system 100 will remain in or depart from a current traffic lane, a prediction whether the system 100 will remain at or depart from a center of its current traffic lane, a prediction whether a travel path of the system 100 might cause the system 100 to strike a pedestrian or other vehicle or other object, or a prediction whether the system 100 can safely change traffic lanes. One or more functional modules 108a-108d may use these or other types of predictions to initiate action or corrective action (if needed), such as alerting an operator of the system 100 or adjusting the operation of the system 100. Example adjustments to the operation of the system 100 may include adjusting the speed of the system 100 (such as by increasing or decreasing the speed of a motor of the system 100 or by applying the brakes of the system 100) or adjusting the direction of travel of the system 100 (such as by altering a steering direction of the system 100). These types of operations can be used to support driving assist features or autonomous driving features in the system 100.

As another example, in DMS applications, multiple functional modules 108a-108d can be used to process input data from one or multiple types of sensors 104, estimate one or more characteristics of an operator of the system 100 based on the sensor measurements, and determine whether to initiate one or more actions based on the one or more estimated characteristics. Example characteristics about the operator of the system 100 could include eyelid positions of the operator's eyes (such as whether the operator's eyes are opened, partially opened, or closed) or a gaze direction of the operator (such as the direction in which the operator appears to be looking while driving). One or more functional modules 108a-108d may use these or other types of estimates to take corrective action (if needed), such as alerting the operator or another party that the operator appears to be inattentive, distracted, drowsy, or otherwise acting unsafely while driving the system 100.

As can be seen here, many real-world applications can involve the use of multiple heterogeneous functional modules 108a-108d, each of which may be designed to process different inputs and generate different outputs (such as localized facial keypoints or three-dimensional eye gaze vectors) using various types of logic (such as different types of computer vision-based processing functions or different types of trained machine learning models). When these various types of functional modules 108a-108d are used together in a system, it is not trivial to determine confidence measures associated with the outputs of the functional modules 108a-108d and to combine the confidence measures for different types of outputs in order to produce final confidence measures for the final outputs from the functional module 108d.

In order to overcome these and other types of issues, each of the functional modules 108a-108d includes or is otherwise associated with an EPD module 110a-110d. Each EPD module 110a-110d may be integrated into its associated functional module 108a-108d or be used in conjunction with the associated functional module 108a-108d. Each EPD module 110a-110d processes information in order to identify at least one confidence measure associated with the output data generated by the associated functional module 108a-108d. The data processed by each EPD module 110a-110d includes any suitable information, such as the input data received by the associated functional module 108a-108d, the output data generated by the associated functional module 108a-108d, or intermediate data generated by the associated functional module 108a-108d. In cases where at least one specified functional module 108a-108d receives input data that includes output data from at least one prior functional module 108a-108d, the EPD module 110a-110d associated with each specified functional module 108a-108d can also process the confidence(s) generated by one or more EPD modules 110a-110d associated with one or more prior functional modules 108a-108d. Thus, for instance, the EPD modules 110b-110c may each receive and process confidence measurements generated by the EPD module 110a, and the EPD module 110d may receive and process confidence measurements generated by the EPD modules 110b-110c. As noted above, each determined confidence may be expressed in any suitable manner, such as a percentage. The confidences generated by the EPD module 110d can represent the overall confidence measurements associated with the outputs of the EPD module 110d, which represent the final outputs from the collection of functional modules 108a-108d in this example arrangement.

Outputs from the collection of functional modules 108a-108d in this example can be used to control the operation of one or more actuators 112 in the system 100. For example, in an automotive vehicle, the one or more actuators 112 may represent one or more brakes, electric motors, or steering components of the vehicle, and the collection of functional modules 108a-108d can be used to apply or discontinue application of the brakes, speed up or slow down the electric motors, or change the steering direction of the vehicle. Also or alternatively, the one or more actuators 112 may represent one or more audible, visible, haptic, or other warnings. The warnings) may be used to indicate that the system 100 is near another vehicle, obstacle, or person, is departing from a current lane in which the vehicle is traveling, or is approaching a possible impact location with another vehicle, obstacle, or person. In general, the specific actuator(s) 112 used and the specific way(s) in which the collection of functional modules 108a-108d may control the actuator(s) 112 in the system 100 can vary depending on the specific system 100 in which the collection of functional modules 108a-108d is being used.

As can be seen in FIG. 1, various functional modules 108a-108d can be arranged in chains, where each chain includes a logical series or sequence of functional modules in which (i) each functional module except the first receives its input data and a confidence measure from a prior functional module and (ii) each functional module except the last provides its output data and a confidence measure to a subsequent functional module. Chains of functional modules may typically overlap one another partially, meaning that at least one functional module 108a-108d may form part of multiple chains of functional modules in the system 100. In the example of FIG. 1, there are two chains of functional modules, namely a first chain including the functional modules 108a, 108b, 108d and a second chain including the functional modules 108a, 108c, 108d.

The concept of a chain of functional modules (and their associated EPD modules) is useful in visualizing how at least some of the EPD modules 110a-110d can operate sequentially in logical terms in the system 100. The first EPD module 110a associated with the first functional module 108a in a chain can determine a confidence measure for an output from that functional module 108a. The next EPD module 110b or 110c associated with the next functional module 108b or 108c in the chain can determine a confidence measure for an output from that functional module 108b or 108c, where that confidence measure is based (at least in part) on the confidence measure provided by the EPD module 110a for the preceding functional module 108a. Similarly, the next EPD module 110d associated with the next functional module 108d in the chain can determine a confidence measure for an output from that functional module 108d, where that confidence measure is based (at least in part) on the confidence measure provided by the EPD module 110b or 110c for the preceding functional module 108b or 108c. As a result, confidence measures can be produced for the outputs from the various functional modules 108a-108d in a pipeline, and those confidence measures can be carried through the pipeline of functional modules so that the final outputs from the pipeline are associated with accurate confidence measures.

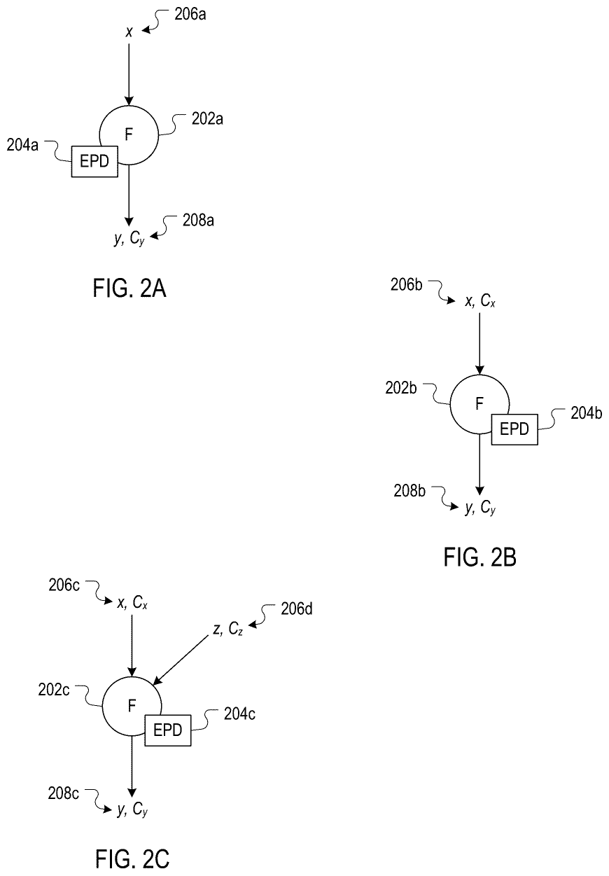

As described below, the EPD modules 110a-111.0d can be configured to determine confidence measures regardless of the associated functional modules' positions within chains, pipelines, or other arrangements of functional modules. For example, FIGS. 2A through 2C illustrate example operations of functional modules 202a-202c and EPD modules 204a-204c in an EPD-based confidence system according to this disclosure. For ease of explanation, it may be assumed that the functional modules 202a-202c could represent various ones of the functional modules 108a-108d and that the EPD modules 204a-204c could represent various ones of the EPD modules 110a-110d.

As shown in FIG. 2A, a functional module 202a may receive input data x 206a, and the functional module 202a and its associated EPD module 204a may generate output data y and an associated confidence measure C_{y} 208a, Here, the functional module 202a can apply any desired function or functions to the input data x in order to generate the output data y, and the desired function or functions can vary widely based on the specific application of the system in which the functional module 202a is used. Similarly, the functional module 202a may receive any desired input data x and produce any desired output data y, which again can vary widely based on the specific application of the system in which the functional module 202a is used. Note that while one instance of input data x and one instance of output data y and its associated confidence measure C_{y} are shown here, the functional module 202a and the EPD module 204a may receive multiple sets of input data x or generate multiple sets of output data y and their associated confidence measures C_{y}. In the system 100 of FIG. 1, the functional module 202a may represent the functional module 108a.

As shown in FIG. 2B, a functional module 202b may receive input data x and an associated confidence measure Cₓ 206b, and the functional module 202b and its associated EPD module 204b may generate output data y and an associated confidence measure 208b. Here, the functional module 202b can apply any desired function or functions to the input data x in order to generate the output data y, and the desired function or functions can vary widely based on the specific application of the system in which the functional module 202b is used. Similarly, the functional module 202b may receive any desired input data x and produce any desired output data y, which again can vary widely based on the specific application of the system in which the functional module 202b is used. In addition, as can be seen here, part of the input to the functional module 202b or the EPD module 204b is a confidence measure Cₓ, which could be produced by an EPD module associated with a prior functional module that generated the input data x. The EPD module 204b can therefore operate to produce its own confidence measure C_{y}, which can represent a confidence measure that is based on both (i) the prior confidence measure Cₓ associated with the input to the functional module 202b and (ii) the calculations performed by the functional module 2021 when generating its output data Note that while one instance of input data and its associated confidence measure Cₓ and one instance of output data y and its associated confidence measure C_{y} are shown here, the functional module 202b and the EPD module 204b may receive multiple sets of input data x and their associated confidence measures (7, or generate multiple sets of output data y and their associated confidence measures C_{y}. In the system 100 of FIG. 1, the functional module 202b may represent the functional module 108b or the functional module 108c.

As shown in FIG. 2C, a functional module 202c may receive multiple sets of input data x and z and their associated confidence measures Cₓ and C_{z} 206c-206d, and the functional module 202c and its associated EPD module 204c may generate output data y and its associated confidence measure C_{y}. 208c, Here, the functional module 202c can apply any desired function or functions to the input data x and z in order to generate the output data y, and the desired function or functions can vary widely based on the specific application of the system in which the functional module 202c is used. Similarly, the functional module 202c may receive any desired input data x and z and produce any desired output data y, which again can vary widely based on the specific application of the system in which the functional module 202c is used. In addition, as can be seen here, part of the input to the functional module 202c or the EPD module 204c is multiple confidence measures Cₓ and C_{z}, which could be produced by multiple EPD modules associated with multiple prior functional modules that generated the input data x and z. The functional module 202c can therefore operate to produce its own confidence measure C_{y}, which can represent a confidence measure that is based on both (i) the prior confidence measures Cₓ and C_{z} associated with the inputs to the functional module 202c and (ii) the calculations performed by the functional module 202c when generating its output data y. Note that while two instances of input data x and z and their associated confidence measures Cₓ and C_{z} and one instance of output data y and its associated confidence measure C_{y} are shown here, the functional module 202c and the EPD module 204c may receive more than two sets of input data x and z and their associated confidence measures Cₓ and C_{z} or generate multiple sets of output data y and their associated confidence measures C_{y}. In the system 100 of FIG. 1, the functional module 202c may represent the functional module 108d.

Again, as can be seen here, the EPD modules 204a-204c can be configured to determine confidence measures regardless of the associated functional modules' positions within chains, pipelines, or other arrangements of functional modules. Moreover, the confidence measures can be propagated through and used by various EPD modules in chains, pipelines, or other arrangements so that the final outputs from a collection of functional modules have associated confidence measures that accurately identify the validity of those final outputs. This allows the final outputs from the collection of functional modules to be further processed along with their associated confidence measures, which allows for consideration of the validity of those final outputs to be taken into account during the further processing. For instance, it is possible for subsequent processing to consider whether a “safe” estimate of driver behavior has a 99% confidence or a 30% confidence, which can make a difference in how the estimate of driver behavior is subsequently used.

The following now provides a mathematical explanation for how some embodiments of the EPD modules 110a-110d, 204a-204c may be implemented in order to determine suitable confidence measures. In particular, the following discussion describes how entropy of predictive distribution can be generalized for use as a unified confidence measure for all functional modules in a chain, pipeline, or other arrangement. The generalized EPI)-based confidence measure can be used with various types of heterogeneous functional modules, such as functional modules that use computer vision algorithms, generic machine learning algorithms, pre-trained deep learning networks, extended deep learning networks with variance networks, or other functional modules. Note that this mathematical explanation is for illustration only and that other mathematical operations may be performed as part of the determinations of the confidence measures by the EPD modules 110a-110d, 204a-204c.

In general, given a specified distribution, it is possible to determine the information entropy (also referred to more generally as entropy) that quantifies the average amount of information or “surprise” of a random variable. If there is no uncertainty in a specified distribution for a specified variable, the entropy is zero. Otherwise, the entropy depends on the distribution of the specified variable. The entropy of a uniform random distribution is higher than the entropy of a Gaussian distribution, and a uniform probability may yield maximum uncertainty and therefore maximum entropy. Thus, given a random variable X and a probability density function ƒ(x) with support Φ, the entropy of the random variable X may be defined as follows.

H(X)=−∫_{Φ}ƒ(x)log ƒ(x)dx (1)

The negative sign of Equation (1) indicates that there is less entropy with higher-probability events. The units of entropy as defined in Equation (1) may depend on the logarithm's base, which in some embodiments could be base two (meaning log₂ is used). Note that Equation (1) is an example only and that entropy can be represented in other forms, such as when represented using a similar form for discrete variables.

This indicates that it is possible to determine the entropy of predictive distribution for any functional module as long as the functional module has an associated predictive distribution. In some cases, the predictive distribution may be defined using the predictive variance representing the precision of the functional module's outputs. This basis for defining an EPD-based confidence system can have various desirable properties. For example, other techniques often use a higher-dimensional vector or matrix (such as a covariance matrix representing the predictive variance of high-dimensional measurements) to represent the confidence intervals or predictive variances of measurements. In contrast, this approach allows a confidence measure to be defined with a single scalar value, even when high-dimensional measurements or other high-dimensional input data is used. Also, determined entropy can be independent of the scale of the random variables (as opposed to the variance), which means that an additional normalization step may not be needed to combine multiple confidence measures. Further, since the EPD-based confidence system is based on predictive distributions, a confidence measure can be directly related to a confidence interval, thereby permitting statistical interpretations to be generated. In addition, the generation of EPD-based confidence measures can be computationally efficient due to features such as approximation using a projection technique, which can make the EPD-based confidence system suitable for use in embedded systems and other resource-constrained systems.

In some cases, it is possible to model the predictive precision of a functional module with a Gaussian distribution. This may be possible, for example, when the functional module is performing a computer vision task, is using a generic machine learning model, or is otherwise using logic having suitable predictive precision. In these cases, given a univariate Gaussian distribution defined as x˜N(μ, σ²), the entropy of the predictive precision of the functional module can be defined as follows.

$$H ( X ) = \frac{1}{2} log ( 2 {πσ}^{2} ) + \frac{1}{2} \qquad ( 2 )$$

Here, μ represents the mean of the Gaussian distribution, and σ represents the standard deviation of the Gaussian distribution. This can also be extended to multivariate Gaussian distributions. In those cases, given a multivariate Gaussian distribution defined as x˜N(μ,Σ), the entropy of the predictive precision of the functional module can be defined in a similar form as follows.

$$H ( X ) = \frac{D}{2} ( 1 + log ( 2 π ) ) + \frac{1}{2} log \vert \sum \vert \qquad ( 3 )$$

$$D = E [ {( x - μ )}^{T} {\sum }^{- 1} ( x - μ ) ] \qquad ( 4 )$$

Here, Σ represents the covariance matrix. In some embodiments, D can be simplified as tr(I_{D}), which means that D can be determined as the trace of an identity matrix. Based on this, it is possible for an EPD module 110a-110d, 204a-204c to determine confidence measures for a functional module when the predictive precision of the functional module can be estimated, such as when the variance or covariance matrix of the functional module can be estimated. It may also be possible to use heuristics or other logic to represent the predictive distribution of a functional module.

As one specific example of this type of approach, assume that a functional module is used to estimate the pose of an operator's head inside a vehicle. This functional module may define a determined head pose estimation as estimated three-dimensional (3D) rotation angles of the driver's head, where the rotation angles may be determined using an input image and detected two-dimensional (2D) facial landmarks of the driver's face. In some cases, the 3D rotation angles may be represented as a 3D vector, which can be expressed as x ∈ R^{3×1}. Also, in some cases, the predictive covariance for the 3D rotation angles may be represented as a 3×3 covariance matrix, which can be expressed as Σ ∈ R^{3×3}. Using heuristics or other logic, it is possible to estimate the covariance matrix. For instance, the predictive variance of an angle can be defined as a weighted estimated angle, such as in the following manner.

$${\sum }_{( i , j )} = \{ \begin{matrix}α ( i ) θ ( i ) , & i = j \\ 0 , & i \neq j\end{matrix} \qquad ( 5 )$$

Here, θ(i) and α(i) represent the estimated rotation angle and its corresponding scale factor, respectively. Given this covariance matrix, the entropy of predictive distribution can be easily determined using Equation (3) above. Note that the determined confidence measure is a scalar value, as opposed to the predictive distribution itself (which is a 3×3 covariance matrix).

In other cases, a functional module may represent or use a deep learning neural network, other deep learning model, or other suitable machine learning model. The uncertainty associated with a deep learning model or other suitable machine learning model may result from uncertainties associated with model parameters and uncertainties due to distributional mismatches between datasets, such as distributional mismatches between training datasets used to train machine learning models and datasets used to test the trained machine learning models. Once the predictive distribution associated with a deep learning model or other suitable machine learning model is known, the predictive distribution can be used as described above to determine EPD values representing confidence measures. Example techniques for modeling the predictive uncertainty of a machine learning model have been proposed in the following documents (all of which are hereby incorporated by reference in their entirety): Malinin et al., “Predictive Uncertainty Estimation via. Prior Networks,” 32nd Conference on Neural Information Processing Systems, 2018; Lakshminarayanan et al., “Simple and Scalable Predictive Uncertainty Estimation using Deep Ensembles,” 31st Conference on Neural Information Processing Systems, 2017 and Kamath et al., “Know Where To Drop Your Weights: Towards Faster Uncertainty Estimation,” arXiv preprint (a06v:2010.1019), 2020. Note, however, that any other suitable technique (now known or later developed) may be used to estimate the predictive distribution associated with a deep learning neural network; other deep learning model, or other machine learning model.

As described above, some of the EPI) modules (such as the EPI) modules 110b-110d and 204b-204c) are responsible for receiving confidence measures determined by prior EPI) modules and combining those confidence measures with confidence measures determined by those EPD modules. For example, each EPD module 110b or 110c can combine the confidence measure from the EPD module 110a with the confidence measure determined by that EPD module 1101) or 110c, and the EPD module 110d can combine the confidence measures from the EPD modules 110b-110c with the confidence measure determined by that EPD module 110d. In some embodiments, the combination of multiple confidence measures can be determined using joint entropy, which combines multiple confidence measures from multiple individual EPI) modules. In some cases, the joint entropy of two discrete variables x and y with respective supports Ωₓ and Ω_{y} can be defined as follows.

H(x,y)=ƒ_{Ω}_{_{y}}∫_{Ω}_{ₓ}p(x,y)log[p(x,y)]dx dy (6)

Here, p(x,y) represents the joint probability associated with the discrete variables X and y. Given a function ƒx→y and the determined entropy from a previous function 11(x) in a chain, a conditional entropy H(y|x) can be defined as follows.

H(y|x)=H(x,y)−H(x) (7)

This represents the new combined entropy of the function given the previous entropy H(x). It should be noted here that the conditional entropy H(y|x) is less than or equal to the joint entropy H(x, y) since H(x)≥0. This relationship can also be extended for more than two random variables. This relationship implies that it is possible to determine a combined entropy as long as the individual entropies can be determined for individual functional modules and the joint entropy can be determined.

In some embodiments, each functional module and its associated EPD module can generate output data y and a corresponding entropy C_{y}. The specific technique for determining the corresponding entropy C_{y} can vary based on (among other things) the specific algorithm being performed by the associated functional module. As noted above, for instance, one technique may be used when computer vision tasks, generic machine learning models, or other functional modules have a predictive precision that can be modeled with a Gaussian distribution, and another technique may be used when deep learning models or other functional modules have a predictive precision that can be estimated in other ways. For the first functional module 108a in a system (such as a functional module used for performing image capture), a constant value may be used for the initial entropy. If x and y are two independent variables, knowing the entropy X of variable x does not affect the entropy Y of variable y, meaning H(y|x)=H(y). The combined entropy for two functional modules may therefore represent the sum of the two individual entropies for the individual functional modules if (and only if) the two functional modules are independent. If not, the approach described above can be used to determine the combined entropy, Note that adding or removing an event with zero probability does not change the confidence.

As one specific example of this type of approach, assume there is a dependency between the accuracy of an eye gaze estimation and the orientation of a vehicle operator's head. In other words, assume the direction that a vehicle operator appears to be looking is dependent on the orientation of the operator's head, which would seem to be a valid assumption. Given joint entropies, it is possible to estimate the confidence of the estimated eye gaze direction if the orientation of the operator's head is known. Thus, when both the head orientation and the eye gaze direction are available, the confidence measures associated with the head orientation and the eye gaze direction can be fused in order to determine the confidence measure of a result determined using the head orientation and the eye gaze direction. The confidence measure associated with a result determined using only the operator's head orientation (such as when the operator's eyes are occluded by sunglasses) can be much higher than the confidence measure of the result determined using both the head orientation and the eye gaze direction.

The ability to provide confidence measures for outputs generated using a collection of functional modules can enable subsequent processing to use both those outputs and those confidence measures when determining whether to take certain actions. In the example above, for instance, a DMS system might ordinarily provide one of its classified labels (such as “safe,” “moderately safe,” “unsafe,” or “extremely unsafe”) when describing a vehicle operator's behavior. However, as noted above, the DMS system cannot represent the validity of its estimates, such as when a user interface always shows the selected class label and ignores the associated uncertainty. In contrast, in some embodiments, the system 100 may provide a probability vector representing the confidence scores of the corresponding labels. For example, the output of the functional module 108d may represent a vector, such as a vector having values [0,7, 0.2, 0.03, 0.02], corresponding to the ordered label set [“safe.” “moderately safe,” “unsafe,” “extremely unsafe”]. A subsequent user interface system, ADAS/AD system, or other system could select the largest value or use the probability vector itself to make a more reliable decision on what (if any) action should be performed based on the value(s). If the entropy of the probability vector is high (such as when the probability vector equals [0,5, 0.5, 0.5, 0.5]), the subsequent system might choose the safest action to implement in order to minimize risk, or the subsequent system might provide the safest feedback to a user. This type of approach can significantly reduce the risk in ADAS/AD systems, DMS systems, and other systems because this type of approach provides both determined results and validities of those determined results.

Note that the modules 108a-108d, 110a-110d shown in FIG. 1 and described above may be implemented in any suitable manner in the system 100. For example, in some embodiments, the modules 108a-108d, 110a-110d may be implemented or supported using one or more software applications or other software instructions that are executed by at least one processor 102, In other embodiments, at least some of the modules 108a-108d, 110a-110d can be implemented or supported using dedicated hardware components. In general, the modules 108a-108d, 110a-110d described above may be performed using any suitable hardware or any suitable combination of hardware and software/firmware instructions.

The processor 102 itself may also be implemented in any suitable manner, and the system 100 may include any suitable number(s) and type(s) of processors or other processing devices in any suitable arrangement. Example types of processors 102 that may be used here include one or more microprocessors, microcontrollers, digital signal processors (DSPs), application specific integrated circuits (ASICs), field programmable gate arrays (FPGAs), or discrete circuitry. Each processor 102 may also have any suitable number of processing cores or engines. In some cases, multiple processors 102 or multiple processing cores or engines in one or more processors 102 may be used to implement the modules 108a-108d, 110a-110d described above. This may allow, for instance, the processor(s) 102 to be used to perform various functions in parallel.

Although FIG. 1 illustrates one example of a system 100 supporting an EPD-based confidence system, various changes may be made to FIG. 1. For example, the system 100 may include any suitable number of functional modules/EPD modules in any suitable arrangement, as long as at least one functional module/EPI) module receives and uses a determined confidence measure from at least one prior functional module/EPD module in order to produce its own confidence measure, Although FIGS. 2A through 2C illustrate examples of operations of functional modules and EPD modules in an EPD-based confidence system, various changes may be made to FIGS. 2A through 2C. For instance, each functional module/EPD module may receive any suitable input(s) and produce any suitable output(s).

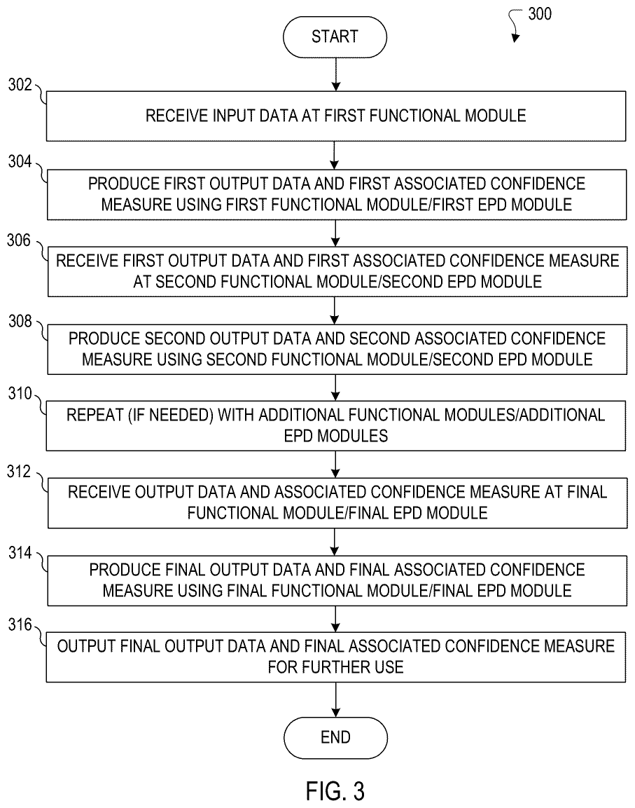

FIG. 3 illustrates an example method 300 for using an EPD-based confidence system according to this disclosure. For ease of explanation, the method 300 is described as being performed using the functional modules 108a-108d and EPD modules 110a-110d in the system 100 of FIG. 1. However, the method 300 may be performed using any other suitable arrangement of functional modules/EPD modules and in any other suitable system.

As shown in FIG. 3, input data is provided to and received at a first functional module at step 302. This may include, for example, images or other measurement data being received at the functional module 108a, such as from one or more sensors 104. First output data and a first confidence measure associated with the first output data are generated at step 304. This may include, for example, the functional module 108a processing the input data x to produce output data y, which can be accomplished by performing any suitable operation(s) using the input data x. This may also include the EPD module 110a determining a confidence measure C_{y} associated with the output data y.

The first output data and the first confidence measure are provided to and received at a second functional module and a second EPD module at step 306. This may include, for example, the output data y and the confidence measure C_{y} being provided from the functional module 108a and the EPD module 110a, and received as input data x and an associated confidence measure Cₓ at another EPD module 110b or 110c. Second output data and a second confidence measure associated with the second output data are generated at step 308. This may include, for example, the functional module 108b or 108c processing the input data x and possibly the confidence measure CA to produce additional output data y, which can be accomplished by performing any suitable operation(s) using the input data x. This may also include the EPD module 110b or 110c determining an additional confidence measure C_{y} associated with the additional output data y. Note that while not shown here, the functional module 108b or 108c and the EPD module 110b or 110c might also receive at least one additional set of input data z and at least one associated confidence measure G for use during the processing.

This processing may be repeated zero or more times at step 310. That is, the output data y and the associated confidence measure C_{y} may be provided as input data x or z and confidence measure Cₓ or C_{z} to one or more additional intermediate functional modules and EPD modules. Eventually, output data and a confidence measure are received at a final functional module and a final EPD module at step 312. This may include, for example, the output data y and the confidence measure C_{y} from at least one functional module and at least one EPD module being received as input data x and an associated confidence measure Cₓ at the final functional module 108d and the final EPD module 110d. Final output data and a final confidence measure associated with the final output data are generated at step 314. This may include, for example, the functional module 108d processing the input data x and the confidence measure Cₓ, to produce final output data y, which can be accomplished by performing any suitable operation(s) using the input data x. This may also include the EPD module 110d determining a final confidence measure C_{y} associated with the final output data y. Note that while not shown here, the functional module 108d and the EPD module 110d might also receive at least one additional set of input data z and at least one associated confidence measure G for use during the processing.

The final output data and final confidence measure are output for further use at step 316. This may include, for example, the functional module 108d and the EPD module 110d providing the final output data and the final confidence measure to at least one additional system or module for use in performing one or more desired functions. The additional system or module may use the final output data and the final confidence measure in any suitable manner, such as by selecting a value in the final output data having the highest final confidence measure or processing all of the values contained in the final confidence measure. The processing may be performed here for any suitable purpose(s), such as any of the ADA.S/AD functions or DMS functions described above.

Although FIG. 3 illustrates one example of a method 300 for using an EPD-based confidence system, various changes may be made to FIG. 3, For example, while shown as a series of steps, various steps in FIG. 3 may overlap, occur in parallel, occur in a different order, or occur any number of times. As a particular example, while FIG. 3 assumes that there are at least three functional modules and associated EPD modules in a chain, an individual chain may include two functional modules and associated. EPD modules or more than three functional modules and associated EPD modules. Also, it is possible to use multiple functional modules and associated EPD modules in parallel with one another. In general, the method 300 is not limited to any particular arrangement of functional modules and associated EPD modules, as long as at least one functional module/EPD module receives and uses a determined confidence measure from at least one prior functional module/EPD module in order to generate its own confidence measure.

Note that many functional aspects of the embodiments described above can be implemented using any suitable hardware or any suitable combination of hardware and software/firmware instructions. In some embodiments, at least some functional aspects of the embodiments described above can be embodied as software instructions that are executed by one or more unitary or multi-core central processing units or other processing device(s). In other embodiments, at least some functional aspects of the embodiments described above can be embodied using one or more application specific integrated circuits (ASICs). When implemented using one or more ASICs, any suitable integrated circuit design and manufacturing techniques may be used, such as those that can be automated using electronic design automation (EPA) tools Examples of such tools include tools provided by SYNOPSYS, INC. CADENCE. DESIGN SYSTEMS, INC., and SIEMENS EDA.

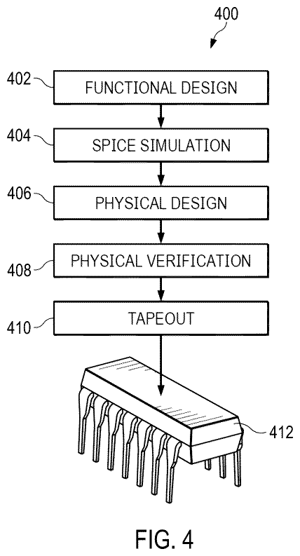

FIG. 4 illustrates an example design flow 400 for employing one or more tools to design hardware that implements one or more functions according to this disclosure. More specifically, the design flow 400 here represents a simplified ASIC design flow employing one or more EDA tools or other tools for designing and facilitating fabrication of ASICs that implement at least some functional aspects of the various embodiments described above. For example, one or more ASICs may be used to implement the functional modules 108a-108d and/or the EPD modules 110a-110d of the system 100.

As shown in FIG. 4, a functional design of an ASIC is created at step 402. For any portion of the ASIC design that is digital in nature, in some cases, this may include expressing the digital functional design by generating register transfer level (RTL) code in a hardware descriptive language (HDL), such as VHDL or VERILOG. A functional verification (such as a behavioral simulation) can be performed on HDL data structures to ensure that the RTL code that has been generated is in accordance with logic specifications. In other cases, a schematic of digital logic can be captured and used, such as through the use of a schematic capture program. For any portion of the ASIC design that is analog in nature, this may include expressing the analog functional design by generating a schematic, such as through the use of a schematic capture program. The output of the schematic capture program can be converted (synthesized), such as into gate/transistor level netlist data structures. Data structures or other aspects of the functional design are simulated, such as by using a simulation program with integrated circuits emphasis (SPICE), at step 404. This may include, for example, using the SPICE simulations or other simulations to verify that the functional design of the ASIC performs as expected.

A physical design of the ASIC is created based on the validated data structures and other aspects of the functional design at step 406. This may include, for example, instantiating the validated data structures with their geometric representations. In some embodiments, creating a physical layout includes “floor-planning,” where gross regions of an integrated circuit chip are assigned and input/output (I/O) pins are defined. Also, hard cores (such as arrays, analog blocks, inductors, etc) can be placed within the gross regions based on design constraints (such as trace lengths, timing, etc.). Clock wiring, which is commonly referred to or implemented as clock trees, can be placed within the integrated circuit chip, and connections between gates-′analog blocks can be routed within the integrated circuit chip. When all elements have been placed, a global and detailed routing can be performed to connect all of the elements together. Post-wiring optimization may be performed to improve performance (such as timing closure), noise (such as signal integrity), and yield. The physical layout can also be modified where possible while maintaining compliance with design rules that are set by a captive, external, or other semiconductor manufacturing foundry of choice, which can make the ASIC more efficient to produce in bulk. Example modifications may include adding extra vias or dummy metal/diffusion/poly layers.

The physical design is verified at step 408, This may include, for example, performing design rule checking (DRC) to determine whether the physical layout of the ASIC satisfies a series of recommended parameters, such as design rules of the foundry. In some cases, the design rules represent a series of parameters provided by the foundry that are specific to a particular semiconductor manufacturing process. As particular examples, the design rules may specify certain geometric and connectivity restrictions to ensure sufficient margins to account for variability in semiconductor manufacturing processes or to ensure that the ASICs work correctly. Also, in some cases, a layout versus schematic (LVS) check can be performed to verify that the physical layout corresponds to the original schematic or circuit diagram of the design. In addition, a complete simulation may be performed to ensure that the physical layout phase is properly done.

After the physical layout is verified, mask generation design data is generated at step 410. This may include, for example, generating mask generation design data for use in creating photomasks to be used during ASIC fabrication. The mask generation design data may have any suitable form, such as GDSII data structures. This step may be said to represent a “tape-out” for preparation of the photomasks. The GDSII data structures or other mask generation design data can be transferred through a communications medium (such as via a storage device or over a network) from a circuit designer or other party to a photomask supplier/maker or to the semiconductor foundry itself. The photomasks can be created and used to fabricate ASIC devices at step 412.

Although FIG. 4 illustrates one example of a design flow 400 for employing one or more tools to design hardware that implements one or more functions, various changes may be made to FIG. 4. For example, at least some functional aspects of the various embodiments described above may be implemented in any other suitable manner.

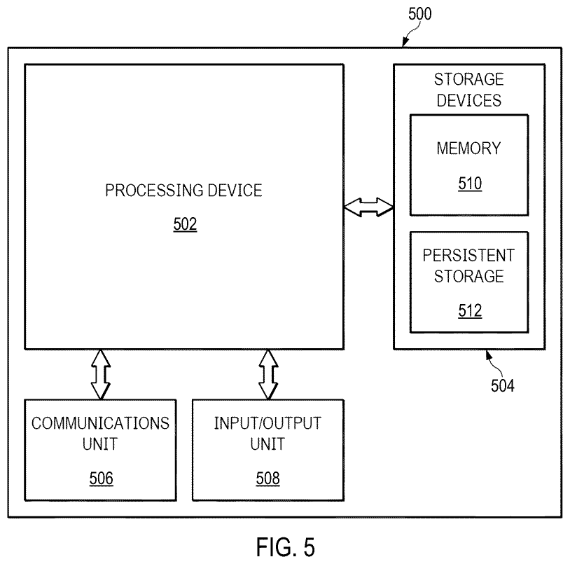

FIG. 5 illustrates an example device 500 supporting execution of one or more tools to design hardware that implements one or more functions according to this disclosure. The device 500 may, for example, be used to implement at least part of the design flow 400 shown in FIG. 4, However, the design flow 400 may be implemented in any other suitable manner.

As shown in FIG. 5, the device 500 denotes a computing device or system that includes at least one processing device 502, at least one storage device 504, at least one communications unit 506, and at least one input/output (I/O) unit 508. The processing device 502 may execute instructions that can be loaded into a memory 510. The processing device 502 includes any suitable number(s) and type(s) of processors or other processing devices in any suitable arrangement. Example types of processing devices 502 include one or more microprocessors, microcontrollers, DSPs, ASICs, FPGAs, or discrete circuitry.

The memory 510 and a persistent storage 512 are examples of storage devices 504, which represent any structures) capable of storing and facilitating retrieval of information (such as data, program code, and/or other suitable information on a temporary or permanent basis). The memory 510 may represent a random access memory or any other suitable volatile or non-volatile storage device(s). The persistent storage 512 may contain one or more components or devices supporting longer-term storage of data, such as a read only memory, hard drive, Flash memory, or optical disc.

The communications unit 506 supports communications with other systems or devices. For example, the communications unit 506 can include a network interface card or a wireless transceiver facilitating communications over a wired or wireless network. The communications unit 506 may support communications through any suitable physical or wireless communication link(s).

The I/O unit 508 allows for input and output of data. For example, the I/O unit 508 may provide a connection for user input through a keyboard, mouse, keypad, touchscreen, or other suitable input device. The I/O unit 508 may also send output to a display or other suitable output device. Note, however, that the I/O unit 508 may be omitted if the device 500 does not require local I/O, such as when the device 500 represents a server or other device that can be accessed remotely.

The instructions that are executed by the processing device 502 include instructions that implement at least part of the design flow 400. For example, the instructions that are executed by the processing device 502 may cause the processing device 502 to generate or otherwise obtain functional designs, perform simulations, generate physical designs, verify physical designs, perform tape-outs, or create/use photomasks (or any combination of these functions). As a result, the instructions that are executed by the processing device 502 support the design and fabrication of ASIC devices or other devices that implement one or more functions described above.

Although FIG. 5 illustrates one example of a device 500 supporting execution of one or more tools to design hardware that implements one or more functions, various changes may be made to FIG. 5. For example, computing and communication devices and systems come in a wide variety of configurations, and FIG. 5 does not limit this disclosure to any particular computing or communication device or system.

In some embodiments, various functions described in this patent document are implemented or supported using machine-readable instructions that are stored on a non-transitory machine-readable medium. The phrase “machine-readable instructions” includes any type of instructions, including source code, object code, and executable code. The phrase “non-transitory machine-readable medium” includes any type of medium capable of being accessed by one or more processing devices or other devices, such as a read only memory (ROM), a random access memory (RAM), a Flash memory, a hard disk drive (HDD), or any other type of memory. A “non-transitory” medium excludes wired, wireless, optical, or other communication links that transport transitory electrical or other signals. Non-transitory media include media where data can be permanently stored and media where data can be stored and later overwritten.

It may be advantageous to set forth definitions of certain words and phrases used throughout this patent document. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
performing data processing operations using multiple functional modules, each functional module configured to perform one or more data processing operations in order to process input data and generate output data; and
for each functional module, generating a confidence measure associated with the output data generated by the functional module;
wherein at least two of the functional modules are configured to operate logically sequentially such that (i) a first of the functional modules provides the output data generated by the first functional module to a second of the functional modules and (1i) the confidence measure associated with the output data generated by the second functional module is based at least partially on the confidence measure associated with the output data generated by the first functional module; and
wherein the multiple functional modules comprise heterogeneous functional modules configured to generate different types of output data.

2. The method of claim 1, wherein the confidence measures are based on entropy of predictive distribution (EPD) values determined using predictive distributions associated with the functional modules.

3. The method of claim 2, wherein the predictive distributions associated with the functional modules comprise at least one of:
a predictive precision modeled using a univariate Gaussian distribution;
a predictive precision modeled using a multivariate Gaussian distribution; and
a predictive precision based on uncertainties associated with a machine learning model's parameters and uncertainties due to distributional mismatches between datasets associated with the machine learning model.

4. The method of claim 2, wherein the EPD value associated with the output data generated by the second functional module is determined as a conditional entropy, the conditional entropy based on (i) the EPD value associated with the output data generated by the first functional module and (ii) a joint entropy.

5. The method of claim 4, wherein the joint entropy is based on a joint probability associated with multiple discrete variables.

6. The method of claim 1, wherein:
a third of the functional modules provides the output data generated by the third functional module to the second functional module; and
the confidence measure associated with the output data generated by the second functional module is based at least partially on (i) the confidence measure associated with the output data generated by the first functional module and (ii) the confidence measure associated with the output data generated by the third functional module.

7. The method of claim 1, wherein:
each functional module includes or is associated with an entropy of predictive distribution (EPD) module; and
each EPD module is configured to determine the confidence measures for the output data generated by the associated functional module.

8. The method of claim 1, wherein:
the functional modules form a pipeline; and
the pipeline is configured to perform at least one advanced driving assist system (ADA S), autonomous driving (AD), or driver monitoring system (DMS) function.

9. The method of claim 8, wherein the heterogeneous functional modules comprise (i) at least one functional module configured to capture images of one or more scenes and (ii) at least one functional module configured to process the images of the one or more scenes.

10. An apparatus comprising:
at least one processing device configured to:
perform data processing operations using multiple functional modules, each functional module configured to perform one or more data processing operations in order to process input data and generate output data; and
for each functional module, generate a confidence measure associated with the output data generated by the functional module;
wherein at least two of the functional modules are configured to operate logically sequentially such that (i) a first of the functional modules is configured to provide the output data generated by the first functional module to a second of the functional modules and (ii) the confidence measure associated with the output data generated by the second functional module is based at least partially on the confidence measure associated with the output data generated by the first functional module; and
wherein the multiple functional modules comprise heterogeneous functional modules configured to generate different types of output data.

11. The apparatus of claim 10, wherein the confidence measures are based on entropy of predictive distribution (EPD) values, the EPD values based on predictive distributions associated with the functional modules.

12. The apparatus of claim 11, wherein the predictive distributions associated with the functional modules comprise at least one of:
a predictive precision modeled using a univariate Gaussian distribution;
a predictive precision modeled using a multivariate Gaussian distribution; and
a predictive precision based on uncertainties associated with a machine learning model's parameters and uncertainties due to distributional mismatches between datasets associated with the machine learning model.

13. The apparatus of claim 11, wherein the EPD value associated with the output data generated by the second functional module represents a conditional entropy, the conditional entropy based on (i) the EPD value associated with the output data generated by the first functional module and (ii) a joint entropy.

14. The apparatus of claim 13, wherein the joint entropy is based on a joint probability associated with multiple discrete variables.

15. The apparatus of claim 10, wherein:
a third of the functional modules is configured to provide the output data generated by the third functional module to the second functional module; and
the confidence measure associated with the output data generated by the second functional module is based at least partially on (i) the confidence measure associated with the output data generated by the first functional module and (ii) the confidence measure associated with the output data generated by the third functional module.

16. The apparatus of claim 10, wherein:
each functional module includes or is associated with an entropy of predictive distribution (EPD) module; and
each EPD module is configured to determine the confidence measures for the output data generated by the associated functional module.

17. The apparatus of claim 10, wherein:
the functional modules form a pipeline; and
the pipeline is configured to perform at least one advanced driving assist system (ADA S), autonomous driving (AD), or driver monitoring system (DMS) function.

18. The apparatus of claim 17, wherein the heterogeneous functional modules comprise (l) at least one functional module configured to capture images of one or more scenes and (ii) at least one functional module configured to process the images of the one or more scenes.

19. A non-transitory machine-readable medium containing instructions that when executed cause at least one processing device to:
perform data processing operations using multiple functional modules, each functional module configured to perform one or more data processing operations in order to process input data and generate output data; and
for each functional module, generate a confidence measure associated with the output data generated by the functional module;
wherein at least two of the functional modules are configured to operate logically sequentially such that (i) a first of the functional modules is configured to provide the output data generated by the first functional module to a second of the functional modules and (ii) the confidence measure associated with the output data generated by the second functional module is based at least partially on the confidence measure associated with the output data generated by the first functional module; and
wherein the multiple functional modules comprise heterogeneous functional modules configured to generate different types of output data.

20. The non-transitory machine-readable medium of claim 19, wherein the confidence measures are based on entropy of predictive distribution (EPD) values, the EPD values based on predictive distributions associated with the functional modules.

21. The non-transitory machine-readable medium of claim 20, wherein the predictive distributions associated with the functional modules comprise at least one of:
a predictive precision modeled using a univariate Gaussian distribution;
a predictive precision modeled using a multivariate Gaussian distribution; and
a predictive precision based on uncertainties associated with a machine learning model's parameters and uncertainties due to distributional mismatches between datasets associated with the machine learning model.

22. The non-transitory machine-readable medium of claim 20, wherein the EPD value associated with the output data generated by the second functional module represents a conditional entropy, the conditional entropy based on (i) the EPD value associated with the output data generated by the first functional module and (ii) a joint entropy.

23. The non-transitory machine-readable medium of claim 22, wherein the joint entropy is based on a joint probability associated with multiple discrete variables.

24. The non-transitory machine-readable medium of claim 19, wherein:
a third of the functional modules is configured to provide the output data generated by the third functional module to the second functional module; and
the confidence measure associated with the output data generated by the second functional module is based at least partially on (i) the confidence measure associated with the output data generated by the first functional module and (ii) the confidence measure associated with the output data generated by the third functional module.

25. The non-transitory machine-readable medium of claim 19, wherein:
each functional module includes or is associated with an entropy of predictive distribution (EPD) module; and
each EPD module is configured to determine the confidence measures for the output data generated by the associated functional module.

26. The non-transitory machine-readable medium of claim 19, wherein:
the functional modules form a pipeline; and
the pipeline is configured to perform at least one advanced driving assist system (ADA S), autonomous driving (AD), or driver monitoring system (DMS) function.

27. The non-transitory machine-readable medium of claim 26, wherein the heterogeneous functional modules comprise (i) at least one functional module configured to capture images of one or more scenes and (ii) at least one functional module configured to process the images of the one or more scenes.
